(19) United States
(12) Patent Application Publication
(10) Pub. No.: US 2004/0130106 A1
(43) Pub. Date: Jul. 8, 2004

(54) Power tool chuck and tool bit shank

(76) Inventors: Tyler J. Dembicks, Raleigh, NC (US); Andrew E. Dembicks, Raleigh, NC (US); Kenneth M. Montjoy, Clemson, SC (US)

Correspondence Address: AKERMAN SENTERFITT, P.O. BOX 3188, WEST PALM BEACH, FL, 33402-3188, US

(21) Appl. No.: 10/653,434

(22) Filed: Sep. 2, 2003

Related U.S. Application Data
(63) Continuation-in-part of application No. 10/349,703, filed on Jan. 22, 2003.
Application No. 10/349,703 is a continuation-in-part of application No. 10/056,840, filed on Jan. 25, 2002, now abandoned.

(51) Int. Cl. B23B 5/22

(52) U.S. Cl. 279/60; 279/9.1; 407/54

(57) ABSTRACT

A power tool chuck and bit shank system for attaching changeable tool bits to a power tool such as a router. The chuck includes a body having a bore which is sized to accept a tool bit shank. At least two movable gripping jaws are included for gripping the tool bit shank, which are moved with a tightening mechanism. At least one flat surface is provided in at least a section of the bore for mating with at least one corresponding flat surface provided on a tool bit shank to prevent rotational movement of the tool bit shank within the bore. A tool bit shank having a flat surface can be gripped in the chuck with hand tightening of the tightening mechanism, and a tool bit shank without a flat surface can be gripped in the chuck with assisted tightening of the tightening mechanism.

### CROSS-REFERENCE TO RELATED APPLICATIONS

This is a continuation-in-part of application Ser. No. 10/349,703, filed Jan. 22, 2003, which was a continuation-in-part of application Ser. No. 10/056,840 filed Jan. 25, 2002.

### BACKGROUND

1. Technical Field

The present invention relates generally to power tools, and more particularly to a chuck system including a chuck and a tool bit shank for use with tools having changeable bits, such as routers.

2. Description of Related Art

Routers can be used to sculpt woodwork such as baseboards or crown moldings. A router typically contains an opening for receiving and securing a router bit that is used for cutting the object to be worked and includes a motor for rotating the router bit. A router can typically receive, secure and rotate a wide variety of router bits, which permits a user to create a large number of designs by changing the router bits according to the depth and shape of cut desired.

To change a router bit, the user usually grasps the cylindrical shank of the router bit with a grasping device such as a pair of pliers or a wrench, a step that can stabilize the router bit during the replacement procedure. Unfortunately, this stabilizing step can damage the shank of the router bit thereby reducing its effectiveness. Moreover, a sudden, unexpected movement of the cutting blades of the router bit may occur if the grasping device slips, which can result in serious injury to the user.

A known router system which employs a chuck for receiving a router bit, and which allows for quick bit changes is disclosed in U.S. Pat. No. 5,947,484 to Huggins et al. The Huggins chuck is complicated to manufacture, as it relies on the use of a plurality of balls that are held in a ball cage. The balls apply a compressive radial force to flexible segments which can grip a tool shank inserted into the chuck. The Huggins chuck also fails to satisfactorily hold router bits if the bits are out of manufacturing tolerance and thus have shanks which are larger or smaller than desired.

In order to simplify the process of changing a tool bit, it is desirable to provide a chuck that allows a user to quickly and simply change tool bits, and which overcomes the limitations of the prior art without significantly increasing costs or design complexity. It is also desirable to provide a chuck which can accept both general purpose traditionally shanked tool bits, and also tool bits having shanks designed to prevent axial and rotational motion of the shank in the chuck. It is desirable if the chuck can allow for the tool bits to be changed without the use of a chuck key.

### SUMMARY OF THE INVENTION

According to an arrangement of the invention, a chuck for attaching changeable tool bits to a power tool comprises a body having a bore therein, the bore being sized to accept a tool bit shank. The chuck also includes at least two movable gripping jaws for gripping a tool bit shank inserted in the bore. A tightening mechanism is included for moving the at least two movable gripping jaws to grip a tool bit shank inserted in the bore. At least one flat surface is provided in at least a section of the bore for mating with at least one corresponding flat surface provided on a tool bit shank to prevent rotational movement of the tool bit shank within the bore. A tool bit shank having at least one flat surface can be gripped in the chuck with hand tightening of the tightening mechanism, and a tool bit shank without at least one flat surface can be gripped in the chuck with assisted tightening of said tightening mechanism.

A mechanism for preventing axial motion of the tool bit shank in the bore may also be provided. The mechanism for preventing axial movement of the tool bit shank in the bore may include a groove for mating with a retaining ring provided on the tool bit shank. The groove may be provided in a gripping surface of the gripping jaws.

The jaws may be movable at an angle to a longitudinal axis of the bore of about 15°. Each jaw may have a concave gripping surface extending parallel with a longitudinal axis of the bore for gripping the tool bit shank. Three jaws may be provided in three bores. The bores may be equiangularly spaced around the tool bit shank bore.

The at least one flat surface provided in the bore may be a shaped area of the bore. The cross-section of the shaped area of the bore may be hexagon, a rectangle, a square, a triangle, a pentagon, a heptagon, an octagon or a star-shape. The flat surface provided in the bore may be a recess.

The tightening mechanism may include a user operable rotatable sleeve, such that rotation of the sleeve causes movement of the gripping jaws. The chuck may also include a rotatable threaded nut which is rotatable by rotation of the user operable sleeve. The gripping jaws may have threads that are engageable by the threaded nut.

The sleeve may have gears engageable with a geared key for assisted tightening of the tightening mechanism. The gears may be provided on an end of the sleeve opposite to an end that receives the tool bit shank in the bore. At least one pilot hole may be included for receiving a pilot of the geared key for stabilizing the key during engagement with the gears.

The chuck may be for use with a router, and the bore may be sized to receive a router bit shank.

According to another arrangement of the invention, a chuck and bit shank system for attaching changeable tool bits to a power tool includes a chuck having a body including a bore therein. The bore is sized to accept a tool bit shank. At least two movable gripping jaws are included for gripping a tool bit shank inserted in the bore. A tightening mechanism is also included for moving the at least two movable gripping jaws to grip a tool bit shank inserted in the bore. At least one flat surface is provided in at least a section of the bore. At least one tool bit is provided, having at least one flat surface provided on a shank thereof to prevent rotational movement of the tool bit shank when within the bore. The tool bit shank having the at least one flat surface can be gripped in the chuck with hand tightening of the tightening mechanism, and a tool bit shank without at least one flat surface can be gripped in the chuck with assisted tightening of the tightening mechanism.

Another arrangement of the invention relates to tool bit having a working section coupled to a shank. The shank includes at least one flat surface thereon for mating with a corresponding flat surface provided on a chuck for preventing rotational movement of the shank in the chuck. The shank also includes a mechanism for preventing axial movement of the shank in the chuck.

The mechanism for preventing axial movement of the tool bit shank in the bore may be a groove for mating with a retaining ring provided on the tool bit shank. The tool bit may be a router bit.

In another arrangement of the invention, a router bit includes at least one shaping body having at least one cutting blade and at least one shank. The shank has an end configured to be coupled to a chuck so that the shank is rotationally fixed relative to the chuck.

The end of the shank may have one of a polygonal shaped cross-section, a rectangular shaped cross-section, a square shaped cross-section, a triangular shaped cross-section, a star-shaped cross-section and a cavity.

In a further arrangement of the invention, a chuck for use with a router includes a body configured to be coupled to a router and has a bore configured to receive a router bit shank. A receiver is positioned at an end of the bore for receiving an end of the router bit shank. The receiver has at least one flat surface to prevent rotational movement of the shank in the bore.

The receiver may have one of a polygonal shaped cross-section, a rectangular shaped cross-section, a square shaped cross-section, a triangular shaped cross-section, and a star-shaped cross-section. Alternatively, a protrusion may be coupled to the receiver for receiving a cavity in the end of the router bit shank.

### BRIEF DESCRIPTION OF THE DRAWINGS

FIG. 1 is a perspective view of a chuck in accordance with the invention.

FIG. 2 is a perspective view of a chuck and a tool bit shank in accordance with the invention.

FIG. 3 is a side view of a chuck and a tool bit shank in accordance with the invention.

FIG. 4 is a side view of a tool bit shank in accordance with the invention.

FIGS. 5a and 5b are a sectional view and an end part-sectional view of a chuck and tool bit shank in accordance with the invention.

FIGS. 6a and 6b are a sectional view and an end part-sectional view of a chuck in accordance with the invention.

FIGS. 7a and 7b are an end view and a sectional view of a sleeve for a chuck in accordance with the invention.

FIGS. 8a and 8b are an end view and a sectional view of a pilot sleeve for a chuck in accordance with the invention.

FIGS. 9a and 9b are a sectional view and an end view of a threaded nut for a chuck in accordance with the invention.

FIGS. 10a and 10b are a side view and an end view of a jaw for a chuck in accordance with the invention.

FIG. 11 is a perspective view of a chuck key for use with a chuck in accordance with the invention.

FIG. 12 is a perspective view of an alternative embodiment of a router bit shank in accordance with the invention and having a square end.

FIG. 13 is a perspective view of an alternative embodiment of a router bit shank in accordance with the invention and having a star-shaped end.

FIG. 14 is a perspective view of an alternative embodiment of a router bit shank in accordance with the invention having a cavity at an end of shank.

### DETAILED DESCRIPTION OF THE PREFERRED EMBODIMENTS

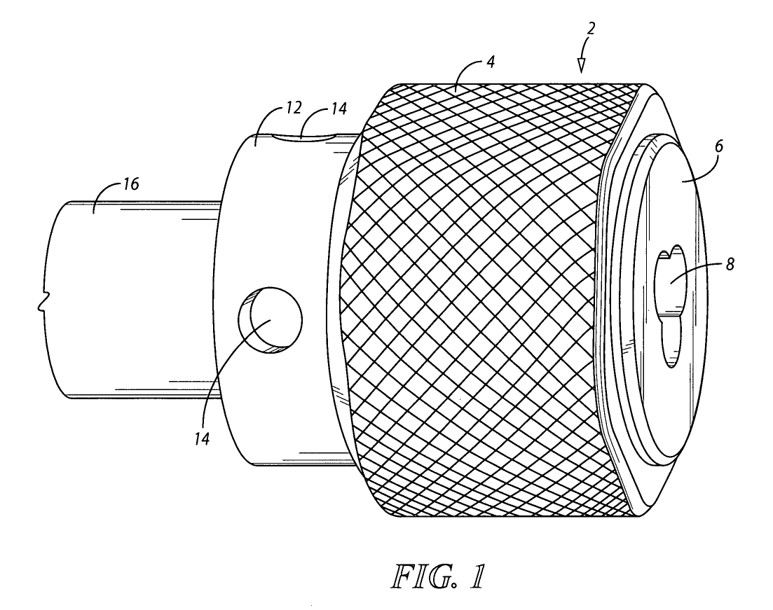

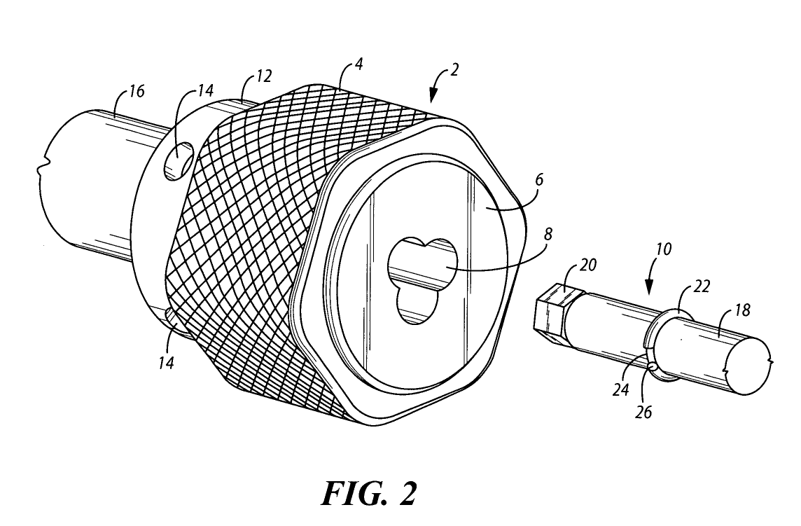

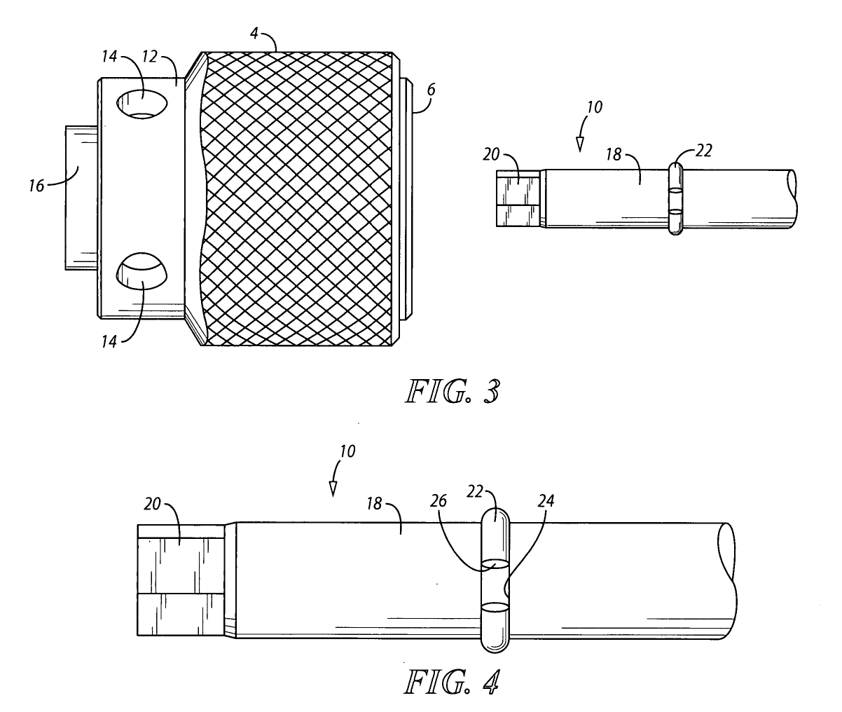

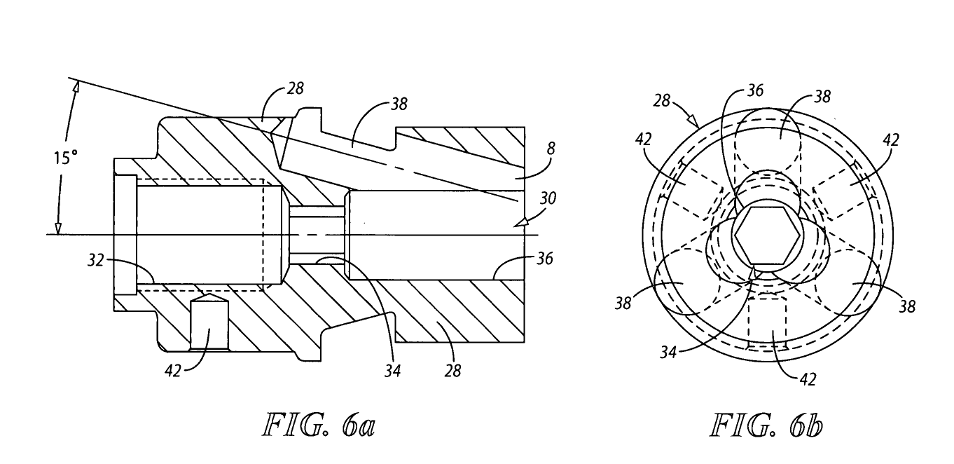

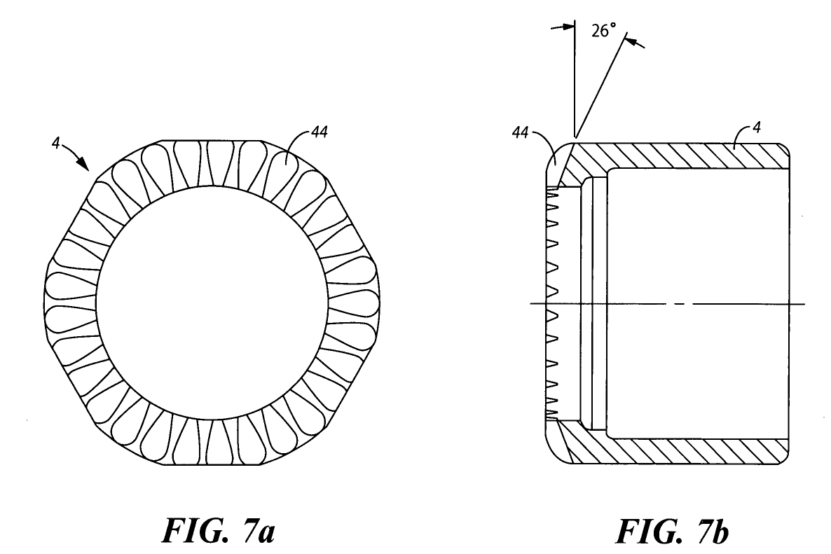

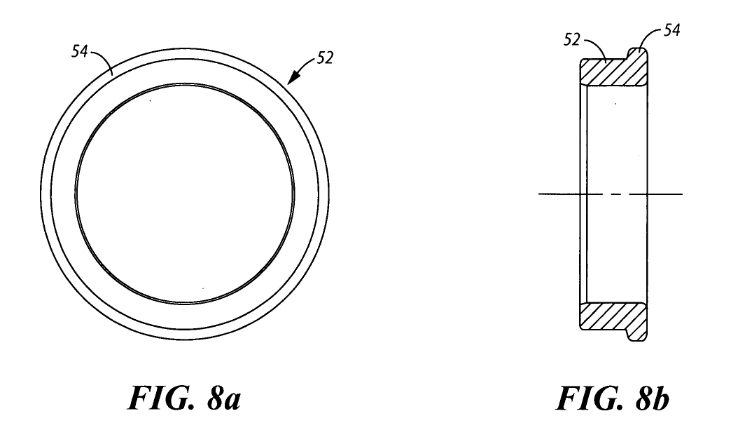

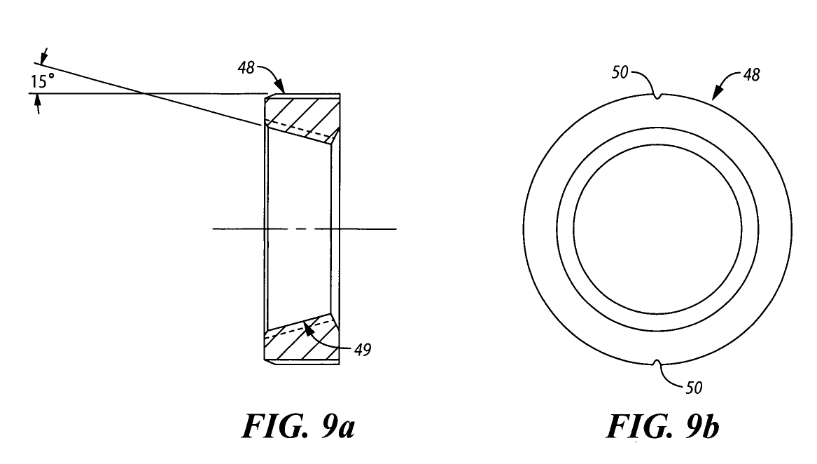

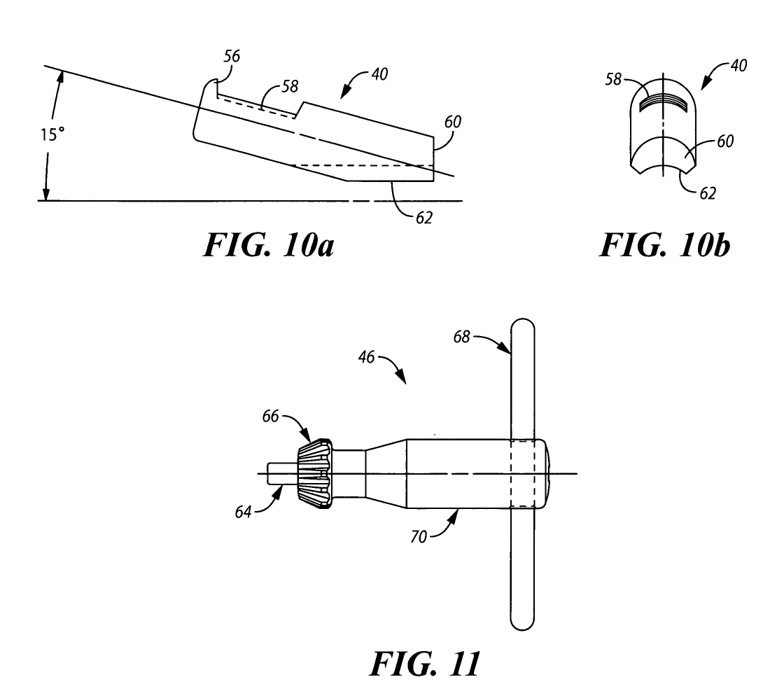

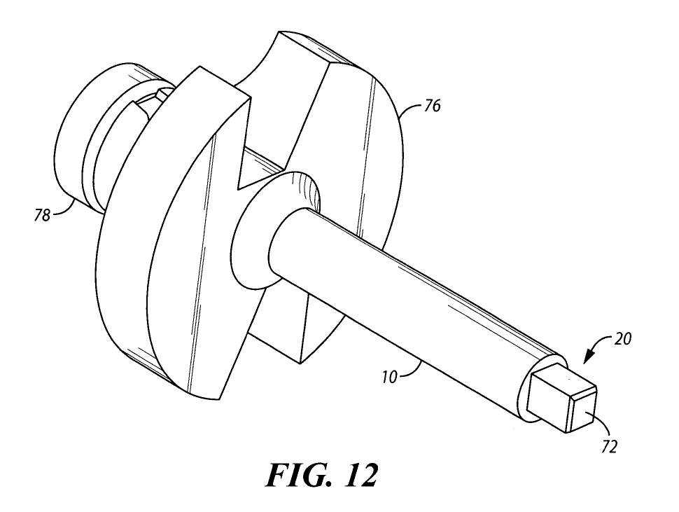

FIGS. 1 to 11 illustrate one embodiment of a chuck and tool bit shank system in accordance with the invention. While the chuck and bit shank system are described herein as a router chuck and a router bit shank respectively for convenience, it will be appreciated that the chuck and tool bit shank system may be used with any suitable power tool where it may be desirable to change tool bits, such as routers, power drills, power screwdrivers, reciprocating saws, dry wall cutters, laminate trimmers and the like.

Turning first to FIGS. 1 to 4, which show external views of the chuck and bit shank system, the chuck 2 can include an outer sleeve 4, an end 6 having an aperture 8 for receiving a shank 10 of a router bit, and a mounting collar 12. The mounting collar 12 may include one or more apertures 14 for receiving a chuck key which will be described in greater detail hereinafter. The mounting collar 12 is used to mount the chuck 2 to a router spindle 16 or any other suitable mounting attachment of a router drive body (not shown).

The router bit shank 10 is sized so that it may be received in the aperture 8 of the chuck 2. The router bit shank 10 may include a generally cylindrical shank portion 18 and a hexagonal shank end 20. The shank end 20 is designed to prevent rotational movement of the router bit shank 10 when it is inserted in the router chuck 2. As will be described hereinafter, the shank end 20 may have any suitable shape which prevents rotational movement of the shank 10 in the chuck 2. Suitable shapes may include those having at least one flat surface, such as triangles, four-sided shapes, pentagons, hexagons, heptagons, octagons, stars, and any other appropriate shape. The opposite end of the shank 10 to the shank end 20 is not shown in FIGS. 1-11 for ease of illustration, but in use may be attached to or may be part of a router guide bearing (not shown) or any other suitable tool.

The router bit shank 10 may also include a retaining ring 22 provided along the cylindrical shank portion 18. The retaining ring 22 may be provided on the router bit shank 10 in a groove 24. The retaining ring 22 may have a break 26 therein, to allow for ease of installation during manufacture.

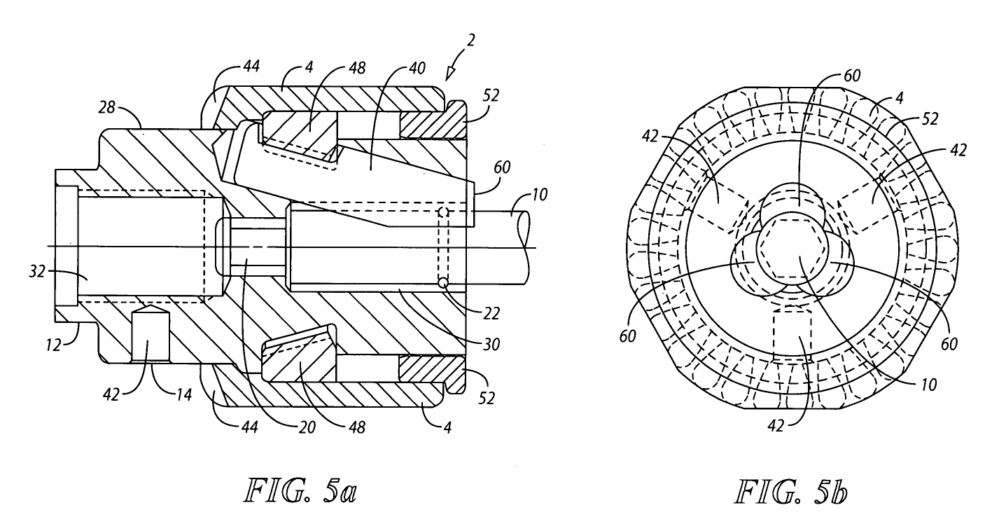

Turning now to FIGS. 5 to 10, which show sectional and part-sectional views of the components of the chuck and bit shank system, further details of the system will be described.

The sleeve 4 is rotatable about a chuck body 28, one end of which forms the mounting collar 12. The chuck body 28 can include a central bore 30, both for receiving the bit shank 10 and for mounting the chuck 2 onto a router drive body. The bore 30 as shown includes three sections of different diameters. A first section 32 of a relatively large diameter may extend through the mounting collar 12 end of the chuck body 28, and may be included for mounting the chuck 2 onto a router drive body. The first section 32 of the bore 30 may be threaded for ease of mounting the chuck. A second, central, section 34 of the bore 30 may be of a relatively small diameter and may be shaped for receiving the shaped end 20 of the router bit shank 10. In the illustrated arrangement, the second section 34 of the bore 30 is hexagonal. A third section 36 of the bore 30 may extend to the end 6 of the mounting body 28, and may be sized to receive the cylindrical shank portion 18 of the router bit shank 10. It will of course be appreciated that the bore 30 need not extend entirely through the chuck body 28 as illustrated, but that separate bores may be provided for mounting the chuck 2 to the router drive body and for receiving the router bit shank 10.

The chuck body 28 may also include three equiangularly spaced bores 38 for receiving jaws 40 of the chuck 2. The bores 38 may extend into and form the part of the third bore section 36. In the illustrated arrangement, the bores 38 are positioned at an angle of about 15° to a longitudinal axis of the chuck body 28. The angle of inclination of the bores 38 is a function of the size of the chuck 2 and the bit shank 10, and may be any suitable angle. The bore section 36 and the bores 38 for receiving the jaws may together form the aperture 8 in the end of the chuck 2, which may have a three-leaf clover shape as illustrated. It will be apparent that the number of bores 38 does not need to be three. There may be two bores 38, or four or more bores 38 may be employed.

Three equiangularly spaced pilot holes 42 may also be included in the chuck body 28. The pilot holes 42 may extend at right angles to the first bore section 32 in the mounting collar 12, and may end at the surface of collar 12 in apertures 14. In the illustrated arrangement, the pilot holes 42 are offset from the bores 38 around the circumference of the chuck body 28. This arrangement may provide added strength to the chuck body 28. It will be appreciated that any suitable number of pilot holes 40 may be employed.

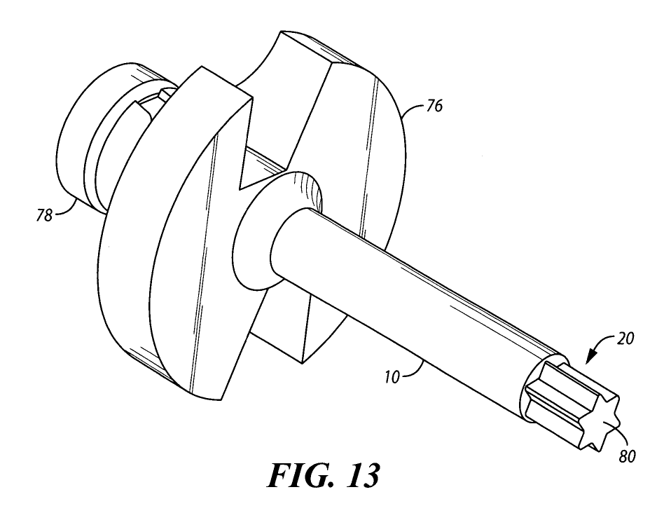

The sleeve 4 may have a geared end 44. The geared end 44 may be positioned adjacent to the mounting collar 12, and may be used with the pilot holes 42 for operating a geared chuck key 46 (shown in FIG. 11). The positioning of the geared end 44 adjacent the mounting collar 12 provides safety advantages because the chuck key 46 may be operated away from the operative end of the tool. This enables a user to obtain easy access to the geared end 44, and if the user slips while operating the chuck key 46, they are less likely to injure themselves on the tool. However, the geared end 44 of the sleeve 4 may be provided in some arrangements on the opposite end of the sleeve 4. As an alternative to the gears 44, a wrench surface may be provided on the sleeve 4 to enable tightening of the sleeve using a wrench. The outer face of the sleeve 4 may be knurled as shown, or may have any suitable gripping protrusions or pattern thereon for ease of manual gripping of the sleeve 4. Alternatively, the outer face of the sleeve 4 may be overlaid with a material such as rubber or a resilient plastic which aids a user in gripping the sleeve 4.

The sleeve 4 may be a tight fit around a rotatable nut 48. The rotatable nut 48 includes internal threads 49, which may be provided at an angle to an axis of the nut 48 of approximately 15°. It will be appreciated that the angle of the threads on the nut 48 is a function of the size of the chuck and bit system, and that any appropriate angle may be employed. The nut 46 may include two fracture assist notches 50.

A pilot sleeve 52 may be provided at end 6 of the chuck body 28. The pilot sleeve 52 may have a lip 54, and is designed to prevent removal of the sleeve 4 from the chuck 2.

Three jaws 40 may be provided, one fitting in each of the bores 38. Of course, if a different number of jaws 40 than three are used, a different number of bores 38 are provided in the chuck body 28, so that the number of bores 38 corresponds with the number of jaws 40. Each jaw 40 may have a recess 56 thereon, and threads 58 may be provided in the recess. The recesses 56 and their threads 58 mate with the internal threads 49 of the rotatable nut 48. Each jaw may define a longitudinal axis, and may have a concave recess 62 cut at approximately 15° to the longitudinal axis, the recess extending along the jaw from an engagement end 60. The concave recess 62 may be shaped to accommodate the cylindrical shank portion 18 of the router bit shank 10. The 15° angle allows the jaw 40 to be inclined by 150 while the recess 62 is parallel to the longitudinal axis of the chuck body. The engagement ends 60 may be generally arc-shaped and may extend through approximately 120° such that three jaws placed in the bores 38 will fit around the circumference of a router bit shank 10. The jaws 40 may have a groove (not shown) in the recesses 62 such that the retaining ring 22 may be held in the groove when the jaws are tightened around the router bit shank 10.

In order to assemble the router, the router bit shank 10 is inserted into the bore 18 until the hexagonal shank end 20 seats in the correspondingly shaped hexagonal bore section 34. The mating flat surfaces on the shank end 20 and the bore section 34 prevent the router bit shank 10 from rotating within the bore 18. The sleeve 4 is then grasped by a user, and rotated. This rotation causes the nut 48 to rotate, with the threads 49 on the nut 48 engaging the threads 58 on the jaws 40. The rotation of the sleeve 4 and nut 48 causes the jaws 40 to be moved along the bores 38 until the recesses 62 tightly contact the cylindrical shank portion 18 of the router bit shank 10, gripping the router bit shank 10. The retaining ring 22 also seats in the groove provided in the jaws 40 to prevent axial movement of the router bit shank. The hexagonal bore section 34 and the hexagonal shank end 20 in addition to the retaining ring 22 aid the secure retention of the shank 10 in the chuck 2. Thus, the router bit shank 10 may be held in place with just manual tightening of the sleeve 4, enabling quick changes of the router bit shanks without the need for additional tightening tools.

The assembly of the router has been described with reference to a router bit shank provided with a shaped end and a retaining ring. If the user desires to use the chuck 2 with a conventionally shanked router bit, which is typically entirely cylindrical, the router bit shank may be inserted into the bore 30 in conventional fashion. An end of the router bit shank will not enter the shaped bore section 34 due to the smaller diameter of the shaped bore section 34. In order to securely grip the bit shank in the chuck 2, a pilot 64 of a geared chuck key 46 may be inserted into one of the pilot holes 42 for stabilization. The gears 66 of the chuck key 46 are meshed with the geared end 44 of the sleeve. The sleeve 4 may thus be rotated using the T-handle 68 of the chuck key 46, which allows a user to obtain a mechanical advantage, leading to a much tighter grip of the router bit shank using the jaws 40 alone than he/she would be able to obtain by manually rotating the sleeve 4. The shank 70 of the chuck key 46 may be varied to suit the type of power tool and the application. A conventionally shanked router bit can thus be securely held in the chuck 2 solely by the force exerted on the shank by the jaws 40.

Thus, a user can quickly and easily change tool bits, using both tools having conventionally shanked bits and tools having shanks with a shaped end and a retaining ring in the same chuck. This removes the need for a user to have separate chucks to accept tools that he/she may already own in addition to a chuck for receiving tools provided with the described mechanisms for preventing rotational and axial movement of the shank. In addition, there is no need for the user to use cumbersome wrenches and other such tools in order to change the tool bit.

It will be appreciated that the mating bore section and shank end, and the retaining ring and groove may be provided together to prevent both radial and axial slipping of the bit shank, however, in some arrangements it may be desirable to provide only one of these means. It will of course be appreciated that the hexagonal bore section 34 and the hexagonal shank end 20 described herein may have any appropriate shape. Alternative arrangements of tool bit shanks are shown in FIGS. 12-14. The tool bits illustrated in FIGS. 12-14 are router bits, but the shank arrangements are of course applicable to any tool bit.

As shown in FIG. 12, the shank 10 may include a four-sided cross-section 72 attached to an end 74 of shank 10, which is positioned generally opposite to the end of shank 10 that is attached to a shaping body 76 having a guide bearing 78. Preferably, the four-sided cross-section 72 is sized and configured to mate with a correspondingly shaped recess or bore in the chuck 2. The four-sided cross-section 72 may be a rectangle, a square, a trapezoid, a parallelogram or other four sided configuration.

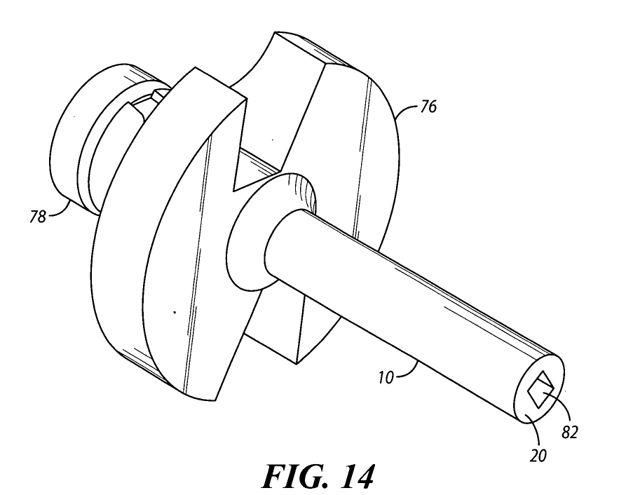

In another embodiment of router bit, as shown in FIG. 13, the section to be received in the chuck 2 may be a star-shaped cross-section 80. The star-shaped cross-section 80 may be attached to end 74 or to another location of shank 10. Star-shaped cross-section 80 may be have five points, six points, as shown in FIG. 13, or more points. Preferably, the star-shaped cross-section 78 is sized and configured to receive a TORX socket or fitting.

In yet another embodiment, as shown in FIG. 14, the section to be received in the chuck 2 may be a cavity 82. Cavity 82 may have any shape capable of receiving a corresponding projection in chuck 2. For instance, cavity 82 may have a cross-section that is elliptical, or polygonal, such as, but not limited to star-shaped, triangular, rectangular, square, hexagonal, or other shape. The star-shaped configurations may have varying number of points, such as, but not limited to five or six pointed stars.

While preferred embodiments of the invention have been illustrated and described, it will be clear the invention is not so limited. Numerous modifications, changes, substitutions and equivalents will occur to those skilled in the art without departing from the spirit and scope of the invention as described in the claims.

What is claimed is:

1. A chuck for attaching changeable tool bits to a power tool comprising:
a body having a bore therein, said bore being sized to accept a tool bit shank;
at least two movable gripping jaws for gripping a tool bit shank inserted in the bore;
a tightening mechanism for moving said at least two movable gripping jaws to grip a tool bit shank inserted in the bore; and
at least one flat surface provided in at least a section of the bore for mating with at least one corresponding flat surface provided on a tool bit shank to prevent rotational movement of the tool bit shank within the bore,
wherein a tool bit shank having at least one flat surface can be gripped in the chuck with hand tightening of said tightening mechanism, and a tool bit shank without at least one flat surface can be gripped in the chuck with assisted tightening of said tightening mechanism.

2. The chuck of claim 1, wherein a mechanism for preventing axial motion of the tool bit shank in the bore is provided.

3. The chuck of claim 2, wherein the mechanism for preventing axial movement of the tool bit shank in the bore comprises a groove for mating with a retaining ring provided on the tool bit shank.

4. The chuck of claim 3, wherein said groove is provided in a gripping surface of said gripping jaws.

5. The chuck of claim 1, wherein the jaws are movable at an angle to a longitudinal axis of the bore of about 15°.

6. The chuck of claim 1, wherein each jaw comprises a concave gripping surface extending parallel with a longitudinal axis of the bore.

7. The chuck of claim 1, wherein three jaws are provided, and wherein three bores are provided for said jaws, said bores being equiangularly spaced around said tool bit shank bore.

8. The chuck of claim 1, wherein the at least one flat surface provided in the bore comprises a shaped area of the bore, and wherein a cross-section of the shaped area of the bore is selected from the group consisting of a hexagon, a rectangle, a square, a triangle, a pentagon, a heptagon, an octagon and a star-shape.

9. The chuck of claim 1, wherein the at least one flat surface provided in the bore comprises a recess.

10. The chuck of claim 1, wherein said tightening mechanism comprises a user operable rotatable sleeve, and wherein rotation of the sleeve causes movement of the gripping jaws.

11. The chuck of claim 10, further comprising a rotatable threaded nut, the threaded nut being rotated by rotation of the user operable sleeve.

12. The chuck of claim 11, wherein the gripping jaws comprise threads engageable by the threaded nut.

13. The chuck of claim 10, wherein the sleeve comprises gears engageable with a geared key for assisted tightening of said tightening mechanism.

14. The chuck of claim 13, wherein the gears are provided on an end of the sleeve opposite to an end that receives the tool bit shank in said bore.

15. The chuck of claim 13, further comprising at least one pilot hole for receiving a pilot of the geared key for stabilizing said key during engagement with said gears.

16. The chuck of claim 1, wherein the chuck is for use with a router, and said bore is sized to receive a router bit shank.

17. A chuck and bit shank system for attaching changeable tool bits to a power tool comprising:
a chuck having a body including a bore therein, said bore being sized to accept a tool bit shank, at least two movable gripping jaws for gripping a tool bit shank inserted in the bore, a tightening mechanism for moving said at least two movable gripping jaws to grip a tool bit shank inserted in the bore, and at least one flat surface provided in at least a section of the bore; and
at least one tool bit having at least one flat surface provided on a shank thereof to prevent rotational movement of the tool bit shank within the bore,
wherein said tool bit shank having at least one flat surface can be gripped in the chuck with hand tightening of said tightening mechanism, and a tool bit shank without at least one flat surface can be gripped in the chuck with assisted tightening of said tightening mechanism.

18. A tool bit comprising:
a working section coupled to a shank,
wherein the shank comprises at least one flat surface thereon for mating with a corresponding flat surface provided on a chuck for preventing rotational movement of the shank in the chuck, and
wherein the shank comprises a mechanism for preventing axial movement of the shank in the chuck.

19. The tool bit of claim 18, wherein the mechanism for preventing axial movement of the tool bit shank in the bore comprises a groove for mating with a retaining ring provided on the tool bit shank.

20. The tool bit of claim 18, wherein the tool bit is a router bit.

21. A router bit, comprising:
at least one shaping body having at least one cutting blade and at least one shank;
wherein the shank has an end configured to be coupled to a chuck so that the shank is rotationally fixed relative to the chuck.

22. The router bit system of claim 21, wherein the end of the shank has one of a polygonal shaped cross-section, a rectangular shaped cross-section, a square shaped cross-section, a triangular shaped cross-section, a star-shaped cross-section and a cavity.

23. A chuck for use with a router, comprising:
a body configured to be coupled to a router and having a bore configured to receive a router bit shank; and
a receiver positioned at an end of the bore for receiving an end of the router bit shank, the receiver having at least one flat surface to prevent rotational movement of the shank in the bore.

24. The chuck of claim 23, wherein the receiver has one of a polygonal shaped cross-section, a rectangular shaped cross-section, a square shaped cross-section, a triangular shaped cross-section, and a star-shaped cross-section.

25. The chuck of claim 23, further comprising a protrusion coupled to the receiver for receiving a cavity in the end of the router bit shank.
